(19) United States
(12) Patent Application Publication
(10) Pub. No.: US 2026/0129577 A1
(43) Pub. Date: May 7, 2026

(54) UPLINK-ORTHOGONAL FREQUENCY DIVISION MULTIPLE ACCESS (UL-OFDMA) TRIGGER-BASED TRANSMISSION ACROSS MULTIPLE LINKS FOR MULTI-LINK OPERATION (MLO)

(71) Applicant: Cisco Technology, Inc., San Jose, CA (US)

(72) Inventors: Sachin Dinkar Wakudkar, St-Sulpice (CH); Brian D. Hart, Sunnyvale, CA (US); Ardalan Alizadeh, Milpitas, CA (US); Sanjay K. Katabathuni, Pleasanton, CA (US); Venkataprasad Chirreddy, Milpitas, CA (US); Jegan Manoharan, Bangalore (IN)

(21) Appl. No.: 18/937,128

(22) Filed: Nov. 5, 2024

(51) Int. Cl. H04W 52/02; H04W 76/15

(52) U.S. Cl. CPC H04W 52/0225; H04W 76/15

(57) ABSTRACT

A method performed by an access point multi-link device (AP MLD) to coordinate trigger-based uplink transmissions across multiple wireless links from a station MLD (STA MLD). The method involves determining an allocation of groups of frequency subcarriers to be used on each wireless link of the multiple wireless links for simultaneous uplink transmission from the STA MLD to the AP MLD; including, in a single trigger frame or in each of multiple trigger frames, information indicating the allocation of groups of frequency subcarriers to be used on each wireless link of the multiple wireless links; and transmitting the single trigger frame on one wireless link of the multiple wireless links, or the multiple trigger frames simultaneously across the multiple wireless links to the STA MLD.

### TECHNICAL FIELD

The present disclosure relates to wireless networking.

### BACKGROUND

Networking architectures have grown increasingly complex in communications environments, particularly wireless networking environments. For wireless local area networks, Institute of Electrical and Electronics Engineers (IEEE) 802.11be (Wi-Fi® 7) defines various features to facilitate Multi-Link Operation (MLO) for Multi-Link Devices (MLDs) that are capable of associating and simultaneously exchange data traffic on multiple Radio Frequency (RF) bands. With MLO, it is possible to increase the throughput for a client device by aggregating multiple links. Currently, in trigger-based transmissions for uplink orthogonal frequency division multiple access (UL-OFDMA), a user information (info) field includes a sub-field in which Resource Units (RUs) are assigned per link for UL-OFDMA. As a result, a client device may not be able to achieve higher throughout since the trigger-based transmission is associated with just a single link.

### BRIEF DESCRIPTION OF THE DRAWINGS

FIG. 1 is a block diagram of a system that may be implemented to enable trigger-based transmissions across multiple links for MLO in a wireless local area network (WLAN), according to an example embodiment.

FIG. 2A is a diagram depicting a technique to transmit a trigger frame on one wireless link to coordinate simultaneous uplink transmissions from a STA MLD to an AP MLD, according to an example embodiment.

FIG. 2B is a diagram depicting a technique to transmit a trigger frame on multiple wireless links to coordinate simultaneous uplink transmissions from a STA MLD to an AP MLD, according to an example embodiment.

FIG. 2C is a diagram showing use of reserved fields in a Block Ack (BA) frame to indicate a specialized multi-link multi-STA Block Ack to be sent by an AP MLD, according to an example embodiment.

FIG. 2D is a diagram showing how an indication of a BA type encoding to signal a multi-link multi-STA BA frame may be achieved, according to an example embodiment.

FIG. 2E is a diagram showing an example of a format of a BA information field for a multi-link multi-STA BA frame to provide per link, per association identifier and per traffic identifier BA information.

FIG. 3 is a diagram depicting including RU allocation information in a sub-field of a trigger frame, according to an example embodiment.

FIG. 4A is a diagram that illustrates alignment of Target Wake Time (TWT) schedules to support synchronization of uplink transmissions across multiple links, according to an example embodiment.

FIG. 4B is a diagram illustrating a field in a TWT control frame that may be modified to include information on a type of trigger frame synchronization (single trigger frame or multiple trigger frames) to be used by an AP MLD, according to an example embodiment.

FIG. 5 illustrates a flow of a method performed by an AP MLD for coordinating simultaneous uplink transmissions from a STA MLD, according to an example embodiment.

FIG. 6 is a hardware block diagram of an AP MLD configured to perform functions associated with operations discussed in connection with embodiments herein.

### DETAILED DESCRIPTION

### Overview

Innovations in wireless access points (APs) and devices have led to the development of Multi-Link Devices (MLDs) that are capable of Multi-Link Operation (MLO). For MLO, MLDs can associate and simultaneously exchange data traffic on multiple Radio Frequency (RF) bands, such as 2.4 Gigahertz (GHz), 5 GHz, and/or 6 GHz bands. MLDs can include AP MLDs and non-AP MLDs, often referred to as MLD client devices, MLD-STAs (STA=abbreviation of station), STA MLDs; and the term ‘client’ include a STA MLD. As referred to herein, the terms ‘link’, ‘wireless link’, and variations thereof can refer to a wireless connection through which a STA (of a STA MLD) can wirelessly connect to/access the wireless connection provided by an AP (of an AP MLD). Each link uses a different channel of a certain bandwidth.

Embodiments presented herein enable coordination of trigger-based transmissions across multiple MLO links so that a MLD client device (STA MLD or non-AP MLD) can take advantage of higher throughput on uplink transmissions using UL-OFDMA across multiple links. An AP MLD is configured to send a trigger frame on one link or on all links to trigger a non-AP MLD (e.g., a STA MLD) to transmit on multiple links.

In one embodiment, a method is provided that is performed by an access point multi-link device (AP MLD) to coordinate trigger-based uplink transmissions across multiple wireless links from a station MLD (STA MLD). The method involves determining an allocation of groups of frequency subcarriers to be used on each wireless link of the multiple wireless links for simultaneous uplink transmission from the STA MLD to the AP MLD; including, in a single trigger frame or in each of multiple trigger frames, information indicating the allocation of groups of frequency subcarriers to be used on each wireless link of the multiple wireless links; and transmitting the single trigger frame on one wireless link of the multiple wireless links, or the multiple trigger frames simultaneously across the multiple wireless links to the STA MLD.

### Example Embodiments

In a wireless local area network (WLAN) or Wi-Fi® network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

Current WLAN/Wi-Fi standards and/or amendments, such as Institute of Electrical and Electronics Engineers (IEEE) 802.11be (and marketed as Wi-Fi 7), define various multi-link features for MLO. Techniques are presented herein to coordinate trigger-based transmissions across MLO links so that a STA MLD (MLD client device) can take advantage of higher throughput using UL-OFDMA across multiple links.

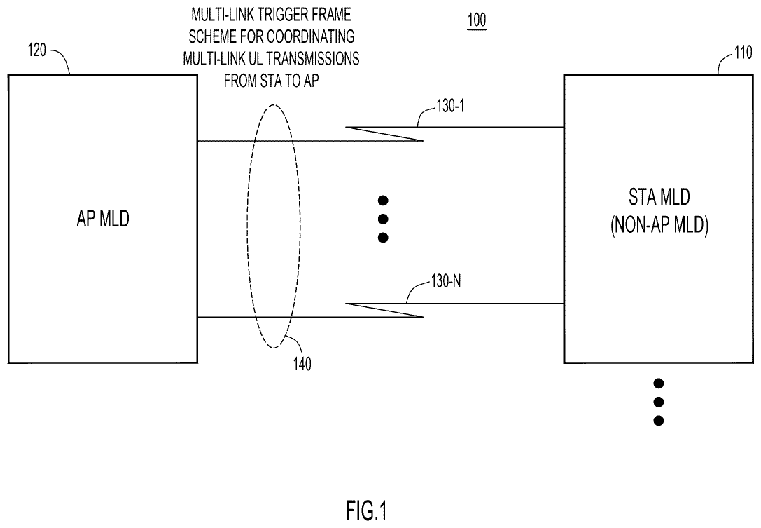

Referring to FIG. 1, FIG. 1 is a block diagram of a system 100 that may be provided to facilitate wireless connectivity exploiting MLO in a WLAN, according to an example embodiment. In at least one embodiment, system 100 may include a WLAN that includes one or more station MLDs (STA MLDs) 110, also referred to herein as non-AP MLDs or clients, that are capable of MLO and a wireless AP that is capable of MLO, referred to as AP MLD 120. (The term STA (without a following “MLD”) refers to a station that is capable of communicating over just a single link.) For MLO, MLDs can associate and simultaneously exchange data/traffic on multiple channels across multiple Radio Frequency (RF) bands, such as 2.4 Gigahertz (GHz), 5 GHz, and/or 6 GHz bands. Thus, as shown in FIG. 1, the AP MLD 120 and the STA MLD can communicate across multiple wireless links (links) 130-1 to 130-N simultaneously.

As explained above, currently, in trigger-based transmissions for uplink orthogonal frequency division multiple access (UL-OFDMA), a user information (info) field in a trigger frame includes a sub-field in which Resource Units (RUs) are assigned for the current link (i.e., the link on which the trigger frame was transmitted) for UL-OFDMA. The term “RU” is used herein to indicate traditional RUs (with contiguous or all-but-contiguous subcarriers), Multi-RUs (MRUs, which are composed of two or more traditional RUs), and Distributed RUs (DRUs, with regularly spaced or all-but-regularly-spaced non-adjacent subcarriers). A STA may not be able to achieve higher throughout since the trigger-based transmission is associated with just a single link.

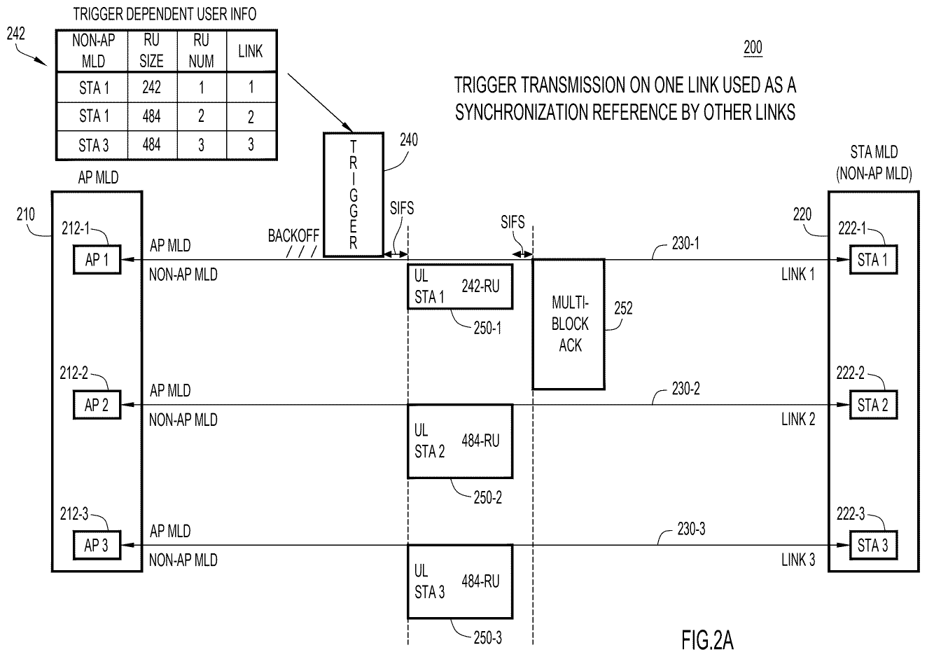

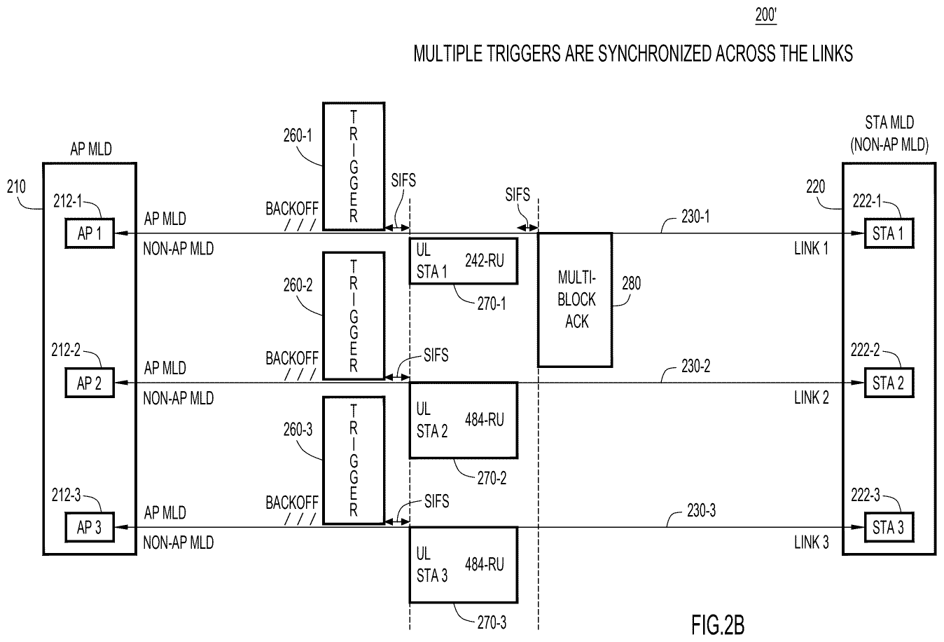

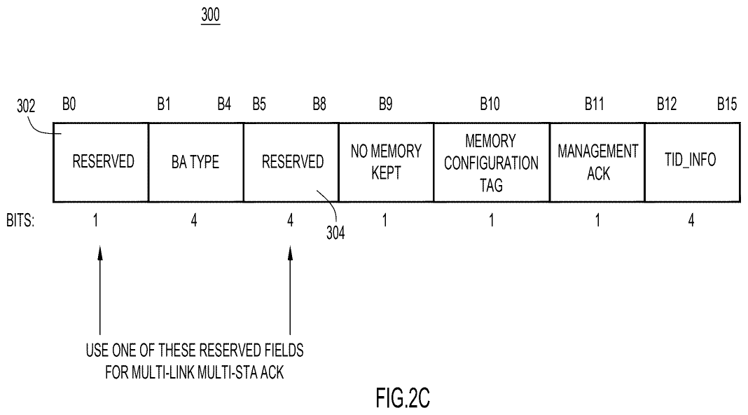

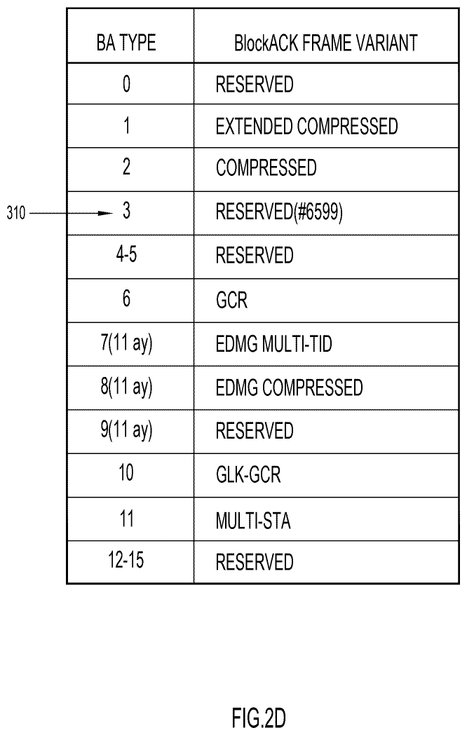

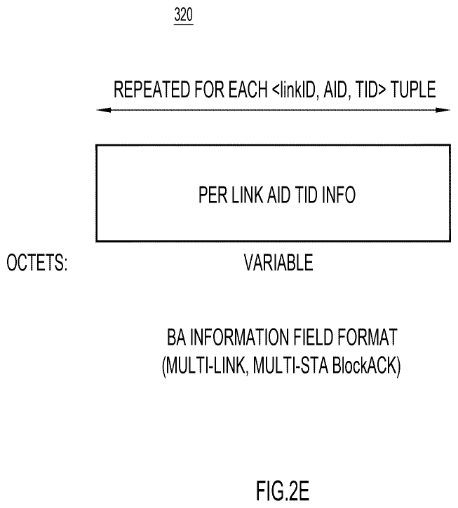

According to the techniques presented herein, a trigger-based transmission is associated with multiple links so that the STA MLD can more fully exploit the throughput enhancements of MLO. That is, a multi-link trigger frame scheme 140 is employed for coordinating multi-link UL transmission from the STA MLD 110 to the AP MLD 120. Examples of the multi-link trigger frame scheme 140 are described below in connection with FIG. 2A - 2E and 3-6.

Reference is now made to FIG. 2A. In the embodiment of FIG. 2A, one of the associated MLD links is used to set up a trigger-based transmission across all of the links. FIG. 2A shows a system 200 that includes an AP MLD 210 and a STA MLD (Non-AP MLD) 220. The AP MLD 210 includes, as an example, 3 APs (separate RF transceivers, baseband processors and MAC processors) each capable of independently transmitting and receiving simultaneously: AP 1, AP 2 and AP 3, denoted by reference numerals 212-1, 212-2 and 212-3. Similarly, the STA MLD 220 includes, as an example, 3 STAs (separate RF transceivers and baseband processors/MAC processors) each capable or independently transmitting and receiving simultaneously: STA 1, STA 2 and STA 3, denoted by reference numerals 222-1, 222-2 and 222-3. Thus, the AP MLD 210 and STA MLD 220 can communicate with each other (simultaneously) over wireless links (links) 230-1, 230-2 and 230-3. In some embodiments, the STA MLD might be associated on these three links (or more) but can only simultaneously transmit and receive on fewer links, such as two of the links.

The AP MLD 210 sends a trigger frame 240 on one of the links, such as link 230-1, as an example, to the STA MLD 220. The trigger frame 240 sent on link 230-1 includes Resource Unit (RU) allocation information to be used by the STA MLD 220 to send (simultaneously) uplink transmissions on links 230-1, 230-2 and 230-3. For example, the trigger frame 240 may use Trigger Dependent User Info sub-field of the User Info field of a trigger frame to list the RU allocation for each uplink transmission to be made on each of the respective links 230-1, 230-2 and 230-3 by STAs 222-1, 222-2 and 222-3, respectively. Assigned RUs to the different links for use by the STA MLD for triggered uplink transmission may be the same or different, but again, they are on different links (and thus in different channels).

FIG. 2A also shows the RU allocation information 242 that is included in the Trigger Dependent User Info sub-field of the trigger frame 240 to indicate the RU assignments for the individual STAs of the STA MLD 220 to use when sending uplink transmissions (simultaneously) to the AP MLD 210. The IEEE 802.11ax amendment specification includes details on the specification of RUs, positions of RUs, size of RUs, etc., that may be assigned/allocated by an AP for use by STAs when transmitting uplink transmissions to the AP, and this is generalized in subsequent amendments (for MRUs and DRUs). Thus, in the example of FIG. 2A, the RU allocation information included in the Trigger Dependent User Info sub-field indicates that: STA 1 is assigned RU number (num) 1 and a RU size of 242, STA 2 is assigned RU number (num) 2 and a RU size of 484, and STA 3 is assigned RU number (num) 3 and a RU size of 484. The IEEE 802.11 standard specifies how the RUs are laid out, but users (e.g., STAs) are assigned to RUs in the course of network operation. The sequence of RUs implies their position. For example, instead of specifying “second ru204” a sequence of RUs is specified “ru106+ru26+ru106 [adding up to approximately ru242, akin to specifying a first ru242]+ru242 [which appears in the second position possible for ru242s so that the receiver then infers it is the second ru242]. In this scenario, the RU number is not sent.

After receiving the trigger frame 240 with the RU allocation information 242, and waiting a Short Interframe Space (SIFS) interval, STA-1, STA-2 and STA-3 simultaneously send uplink (UL) transmissions 250-1, 250-2 and 250-3, on their respective allocated RUs, over links 230-1, 230-2 and 230-3, respectively. After another SFS interval, the AP MLD 210 sends a Multi-Block Acknowledgement (Ack) 252 to the STA MLD. Examples of the Multi-Block Ack 252 are described below in connection with FIG. 2C - 2E.

The STA MLD 220 uses the trigger transmission (trigger frame 240) received on one link as a synchronization reference for timing and carrier frequency offset (also known as parts per million (ppm) offset) for all the links 230-1, 230-2 and 230-3.

Reference is now made to FIG. 2B for description of another embodiment. The arrangement of system 200′ is similar to that of FIG. 2A, with the AP MLD 210 and STA MLD 220. In the embodiment of FIG. 2B, there is a coordinated set of trigger frames, one trigger frame per link. The trigger frames are synchronized across all links so that the uplink transmission for the STA MLD 220 is also synchronized in time on the assigned RUs across the links. This time synchronization is useful because it can ensure that the STA MLD 220 does not need to receive while transmitting, thereby simplify the RF design requirements of the STA MLD 220.

Specifically, the AP MLD 210 transmits trigger frames 260-1, 260-2 and 260-3 over links 230-1, 230-2 and 230-3, respectively, to the STA MLD 220. Each trigger frame 260-1, 260-2 and 260-3 includes the RU allocation information shown in FIG. 2B included in trigger frame 240. After receiving the trigger frames 260-1, 260-2 and 260-3, the STA MLD 220 transmits the UL transmissions 270-1, 270-2 and 270-3 on the allocated RUs via links 230-1, 230-2 and 230-3. The AP MLD 210 then sends a Multi-Block Ack 280 to the STA MLD 220.

Examples of the Multi-Block Ack 252 shown in FIG. 2A and the Multi-Block Ack 280 shown in FIG. 2B transmitted by the AP MLD to the STA MLD, are now described. The Multi-Block Ack 252 and 280 may consist of a regular Ack, a Block Ack (BA), a multi-STA BA, or a new BA type called a multi-link multi-STA BA, as described herein. The multi-link multi-STA BA may use one of the reserved fields in a BlockAck frame shown in FIG. 2C. FIG. 2C shows a BA control field 300 as defined in the IEEE 802.11ax and 802.11ay standard specification. According to the embodiments presented herein, the Reserved fields 302 and 304 can be enhanced to include the multi-link multi-STA BA information. This allows for support for the AP MLD to send an acknowledgment of frames sent by multiple STAs across multiple links, and as a result, reduces acknowledgement airtime across the links.

FIG. 2D shows the BlockAck frame variant encoding for IEEE 802.11ax where BA Type 3, shown at reference 310, which is reserved, may be used to signal the encoding used for the multi-link multi-STA BA type shown in FIG. 2C.

In still another embodiment, an association identifier (AID) management entity (AME) may be provided to allocate unique AIDs for the STAs across the multiple links, and thereby leverage a unique association ID/traffic ID (AID/TID) pair for acknowledgment to be sent by the AP MLD to a received triggered uplink transmission. Moreover, the <TID,AID> tuple may be extended with a link ID to identify a unique STA across links. FIG. 2E shows an example of a format for a BA information field 320 for a multi-link multi-STA BlockAck. The BA information field 320 is configured for a variable length and provides per link AID, TID information. In other words, the BA information field 320 is repeated for each <linkID, AID,TID> tuple.

In still another embodiment, the transmitter (e.g., AP MLD or non-AP MLD) pools all the received Media Access Control (MAC) Protocol Data Units (MPDUs) from all the multiple wireless links and sends a single BA bitmap for the pooled information.

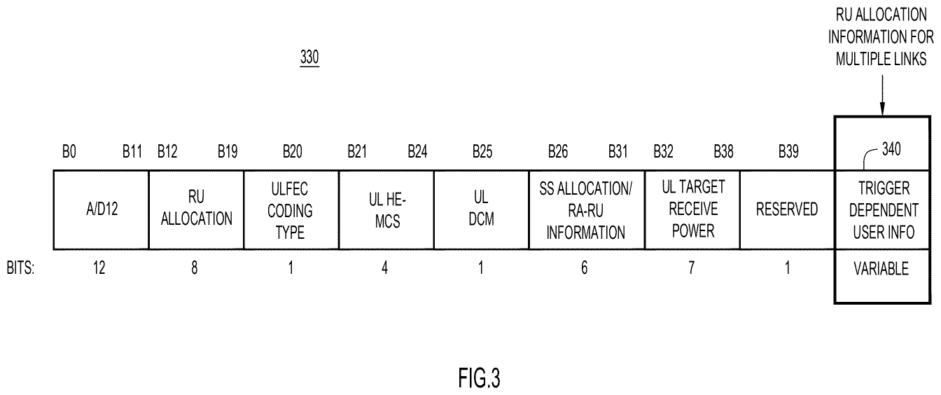

As explained above, the Trigger Dependent User Info sub-field of a trigger frame may be used to assign RUs for a given STA MLD across multiple links. FIG. 3 shows a format of a User Info Field 330 that is included in a trigger frame. As explained above, the RU allocation information for each of multiple links may be included in the Trigger Dependent User Info sub-field 340. The various other fields of the User Info Field 330 are defined by the IEEE 802.11ax amendment specification and subsequent amendments such as IEEE 802.11be and IEEE 802.11bn.

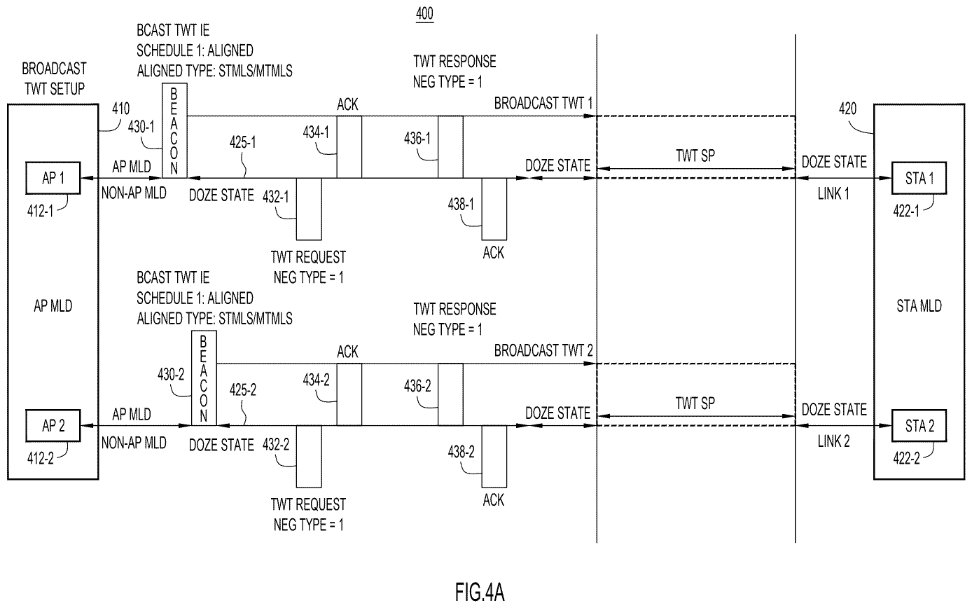

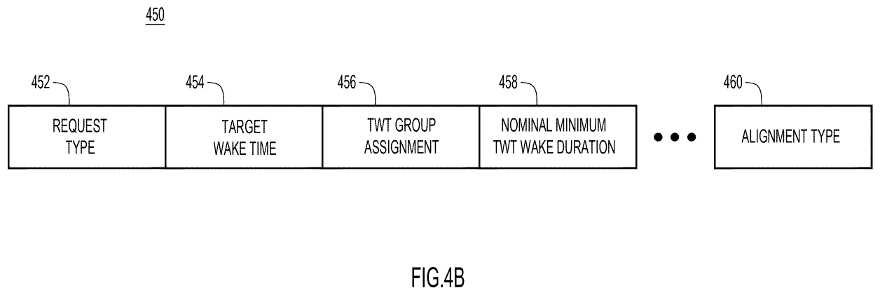

Reference is now made to FIGS. 4A and 4B. FIG. 4A shows a Target Wake Time (TWT) service period (SP) can be at least generally aligned to support synchronous transmission across multiple links. TWT is a feature of Wi-Fi 6 that allows wireless APs and clients to define specific times or schedules for accessing the wireless network. Clients wake up at TWT service periods and generally remain in sleep mode at other times, extending their battery life.

FIG. 4A shows a sequence diagram 400 for the signaling between a AP MLD 410 having two APs 412-1 (AP 1) and 412-2 (AP 2) and an STA MLD 420 having two STAs 422-1 (STA 1) and 422-2 (STA 2). The AP MLD 410 communicates via two wireless links 425-1 and 425-2 (denoted Link 1 and Link 2 in the figure), simultaneously, with STA MLD 420. AP 412-1 of AP MLD 410 broadcasts a beacon 430-1 on wireless link 425-1 and AP 412-2 broadcasts beacon 430-2 on wireless link 425-2. Each beacon 430-1 and 430-2 includes a TWT Information Element (IE) that indicates an indication that the TWT schedule is to be aligned with the multi-link triggered schedule, and also the type of alignment. For example, the TWT IE for beacon 430-1 indicates “Schedule 1: Aligned” is used, where the TWT SP schedule is aligned with the multi-link triggered uplink schedule, and indicates “Aligned Type: STMLS/MTMLS” meaning that the alignment type is to support alignment with Single Trigger Multi-Link Synchronization (STMLS) or Multi Trigger Multi-Link Synchronization (MTMLS).

Based on the information contained in the beacons 430-1 and 430-2, STA 422-1 of the STA MLD 420 sends an TWT Request frame 432-1 and STA 422-2 of the STA MLD 420 sends an TWT Request frame 432-2. The TWT Request frames 432-1 and 432-2 indicate a Negotiation (Neg) Type=1. The AP MLD 410 sends Ack frames 434-1 and 434-2 to the TWT Request frames 432-1 and 432-2, respectively. The AP MLD 410 then sends a TWT Response frame 436-1 to the TWT Request frame 432-1, and sends a TWT Response frame 436-2 to the TWT Request frame 432-2. The TWT Response frames 436-1 and 436-2 indicate the Neg Type=1, and thus confirms the requested TWT. The STA MLD 420 sends Ack frames 438-1 and 438-2 to the TWT Response frames 436-1 and 436-2, respectively. Thereafter, STA-1 goes into a doze state for the TWT SP on Link 1 and likewise STA-2 goes into a doze state on Link 2.

Turning to FIG. 4B, a diagram is shown of an individual TWT parameter set field 450. The individual TWT parameter set field 450 includes octets for Request Type 452, Target Wake Time 454, TWT Group Assignment 456, Nominal Minimum TWT Wake Duration 458, and various other fields, and in particular including an octet for Alignment Type 460. The Alignment Type 460 can be a 3-bit type field:
Value 0: Aligned TWT schedule
Value 1: STMLS
Value 2: MTMLS

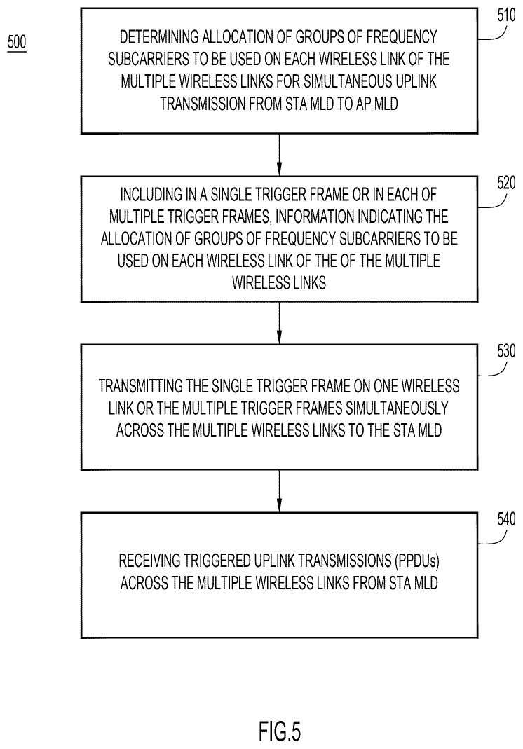

Reference is now made to FIG. 5, a flow chart is shown for a method 500 according to an example embodiment. The method 500 is performed by a AP multi-link device (AP MLD) to coordinate trigger-based uplink transmissions across multiple wireless links among wireless links setup between the AP MLD and a station MLD (STA MLD). The method 500 includes, at step 510, determining an allocation of groups of frequency subcarriers (e.g., Resource Units) to be used on each wireless link of the multiple wireless links for simultaneous uplink transmission from the STA MLD to the AP MLD. At step 520, the method 500 involves including, in a single trigger frame or in each of multiple trigger frames, information indicating the allocation of groups of frequency subcarriers to be used on each wireless link of the of the multiple wireless links. At step 530, the 500 involves transmitting the single trigger frame on one wireless link or the multiple trigger frames simultaneously across the multiple wireless links to the STA MLD. At step 540, the AP MLD receives, simultaneously, triggered uplink transmissions across the multiple wireless links from the STA MLD. The triggered uplink transmissions may be physical layer protocol data units (PPDUs). It is to be noted that due to the channel busy/idle situation for a given link, in some fraction of cases, not all triggered uplink transmissions may succeed. A triggered uplink transmission may actually be sent on no link, just one link, just 2 lines, etc. If a link is determined by the STA or a STA MLD to be busy, and transmission on the link is not permitted at the current time, then the STA MLD may still continue to transmit the triggered RUs on the other idle links. To support this mode of operation, the STA MLD sends separate physical service data units (PSDUs) on a respective link, and the PSDUs are independently encoded.

Related to this issue of busy or idle channels, the AP MLD may perform carrier sense multiple access (CSMA) techniques to determine whether a link is free (on certain RUs) before triggering an uplink transmission from the STA MLD on those RUs on that link.

As explained above in connection with FIGS. 2A and 2B, the information indicating the allocation of groups of subcarriers may comprise information indicating Resource Unit (RU) number and RU size to be used on each wireless link of the multiple wireless links. The term RU denotes a group of frequency subcarriers.

As described above in connection with FIG. 2A, step 530 of transmitting the trigger frame may involve transmitting the single trigger frame on one wireless link of the multiple wireless links. The single trigger frame may be used as a synchronization reference by the STA MLD for timing and carrier frequency offset for the multiple wireless links.

As described above in connection with FIG. 2B, step 530 of transmitting may involve transmitting multiple trigger frames (multiple instances of the trigger frame), one on each of the multiple wireless links. The multiple trigger frames transmitted across the links may be synchronized so that the uplink transmissions from the STA MLD are synchronized across the multiple wireless links.

As described above in connection with FIG. 3, the information indicating the allocation of groups of subcarriers for each of the multiple wireless links may be included in a Trigger Dependent User Info sub-field of a User Info field of the trigger frame.

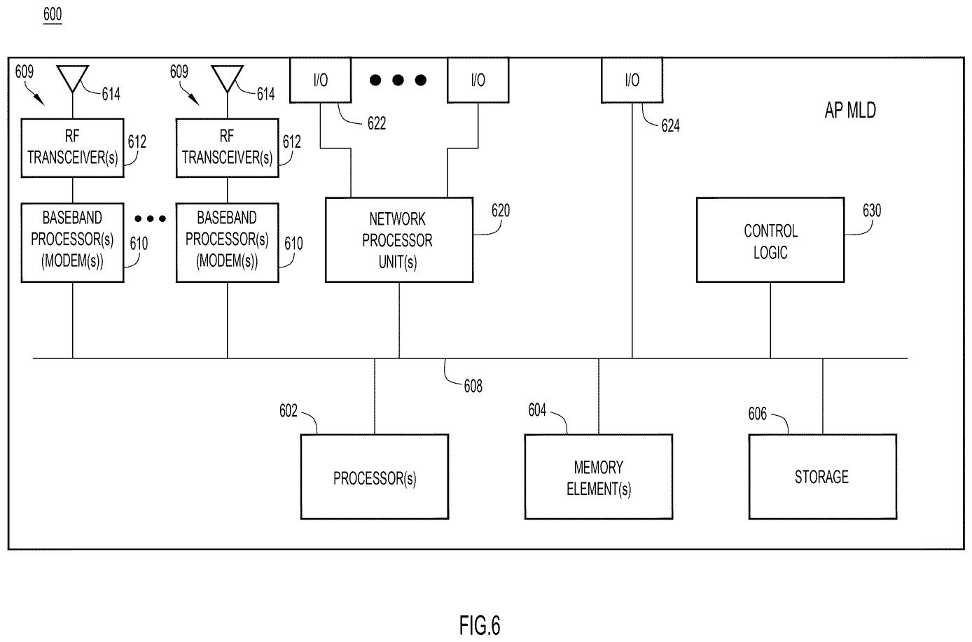

Referring to FIG. 6, FIG. 6 illustrates a hardware block diagram of an AP MLD 600 that may perform functions associated with operations discussed herein in connection with the techniques described for embodiments herein.

In at least one embodiment, the AP MLD 600 may be any apparatus that may include one or more processor(s) 602, one or more memory element(s) 604, storage 606, a bus 608, a plurality of AP modules 609 each consisting of a baseband processor (modem) 610, one or more RF transceivers 612 and an antenna 614 (or group of antennas). The AP MLD 600 may further include one or more network processor unit(s) 620 interconnected with one or more network input/output (I/O) interface(s) 622, one or more I/O interface(s) 624, and control logic 630. In various embodiments, instructions associated with logic for AP MLD 600 can overlap in any manner and are not limited to the specific allocation of instructions and/or operations described herein.

In at least one embodiment, processor(s) 602 is/are at least one hardware processor configured to execute various tasks, operations and/or functions for AP MLD 600 as described herein according to software and/or instructions configured for AP MLD 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with AP MLD 600, and/or logic configured for memory element(s) 604 and/or storage 606. For example, any logic described herein (e.g., control logic 630) can, in various embodiments, be stored for AP MLD 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of AP MLD 600 to communicate in order to exchange information and/or data. Bus 608 can be implemented with any architecture designed for passing control, data and/or information between processors, memory elements/storage, peripheral devices, and/or any other hardware and/or software components that may be configured for AP MLD 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 620 may enable communication between AP MLD 600 and other systems, entities, etc., via network I/O interface(s) 622 (wired and/or wireless) to facilitate operations discussed for various embodiments described herein. In various embodiments, network processor unit(s) 620 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between AP MLD 600 and other systems, entities, etc. to facilitate operations for various embodiments described herein. In various embodiments, network I/O interface(s) 622 can be configured as one or more Ethernet port(s), Fibre Channel ports, any other I/O port(s), and/or antenna(s)/antenna array(s) now known or hereafter developed. Thus, the network processor unit(s) 620 and/or network I/O interface(s) 622 may include suitable interfaces for receiving, transmitting, and/or otherwise communicating data and/or information (wired and/or wirelessly) in a network environment.

I/O interface(s) 624 allow for input and output of data and/or information with other entities that may be connected to AP MLD 600. For example, I/O interface(s) 624 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 612 may perform RF transmission and RF reception of wireless signals via antenna(s) 614, and the baseband processor or modem 610 performs baseband modulation and demodulation, etc. associated with such signals to enable wireless communications for AP MLD 600.

In various embodiments, control logic 630 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 630) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include a method as shown and described herein. In one form an apparatus as shown and described herein is provided. In one form, a system as shown and described herein is provided. In one form, one or more computer readable storage media encoded with software comprising computer executable instructions is/are provided herein that, when the software, is/are executed operable to perform operations as shown and described herein.

In some aspects, the techniques described herein relate to a method by an access point multi-link device (AP MLD) to coordinate trigger-based uplink transmissions across multiple wireless links among wireless links setup between the AP MLD and a station MLD (STA MLD), including: determining an allocation of groups of frequency subcarriers to be used on each wireless link of the multiple wireless links for simultaneous uplink transmission from the STA MLD to the AP MLD; including, in a single trigger frame or in each of multiple trigger frames, information indicating the allocation of groups of frequency subcarriers to be used on each wireless link of the multiple wireless links; and transmitting the single trigger frame on one wireless link of the multiple wireless links, or the multiple trigger frames simultaneously across the multiple wireless links to the STA MLD.

In one form, the information indicating the allocation of groups of subcarriers includes information indicating Resource Unit (RU) position and RU size to be used on each wireless link of the multiple wireless links, wherein a Resource Unit denotes a group of frequency subcarriers.

In one form, the method further includes simultaneously receiving multiple triggered uplink transmissions, one triggered uplink transmission on each wireless link of the multiple wireless links, from the STA MLD.

In some aspects, the method further includes transmitting on one wireless link of the multiple wireless links or on all the multiple wireless links, a multi-link multi-STA block acknowledgment frame with an identifier for a STA of the STA MLD to acknowledge reception by the AP MLD of a triggered uplink transmission from the STA of the STA MLD.

In some aspects, the multi-link multi-STA block acknowledgment frame includes a single block acknowledgment bitmap for all of the multiple wireless links after pooling all received Media Access Control (MAC) Protocol Data Units (MPDUs) from all the multiple wireless links.

In some aspects, the multi-link multi-STA block acknowledgment frame includes link identifier(s), association identifier(s) and traffic identifier(s) to indicate acknowledge of reception of triggered uplink transmissions from the STA MLD.

In some aspects, transmitting includes transmitting to the STA MLD the single trigger frame on one wireless link of the multiple wireless links.

In some aspects, the single trigger frame is used as a synchronization reference by the STA MLD for timing and carrier frequency offset for the multiple wireless links.

In some aspects, transmitting includes transmitting the multiple trigger frames to the STA MLD, each of the multiple trigger frames being transmitted on a corresponding one of the multiple wireless links.

In some aspects, the multiple trigger frames transmitted across the multiple wireless links are synchronized so that in turn triggered uplink transmissions from the STA MLD are synchronized across the multiple wireless links.

In some aspects, the information indicating the allocation of groups of subcarriers for each of the multiple wireless links is included in a Trigger Dependent User Info sub-field of a User Info field of the single trigger frame or in each of the multiple trigger frames.

In some forms, the method further includes: including in a Target Wake Time (TWT) control frame information to indicate alignment of TWT schedule periods across the multiple wireless links, and information to indicate single trigger multi-link synchronization across the multiple wireless links with the single trigger frame or multi trigger multi-link synchronization across the multiple wireless links with the multiple trigger frames.

The techniques described herein also relate to, or may be embodied in, an apparatus including: a plurality of access point modules each configured to wireless communicate over an associated wireless link of a plurality of wireless links for an access point multi-link device (AP MLD) with a station MLD (STA MLD); and a processor coupled to the plurality of access point modules, the processor configured to perform operations including: determining an allocation of groups of frequency subcarriers to be used on each wireless link of the plurality of wireless links for simultaneous uplink transmission from the STA MLD to the AP MLD; including, in a single trigger frame or in each of multiple trigger frames, information indicating the allocation of groups of frequency subcarriers to be used on each wireless link of the plurality of wireless links; and causing the single trigger frame to be transmitted by one of the plurality of access point modules on one wireless link of the plurality of wireless links, or causing the plurality of access point modules to each simultaneously transmit the multiple trigger frames across the plurality of wireless links to the STA MLD.

In some aspects, the information indicating the allocation of groups of subcarriers includes information indicating Resource Unit (RU) position and RU size to be used on each wireless link of the plurality of wireless links, wherein a Resource Unit denotes a group of frequency subcarriers.

In some aspects, the plurality of access point modules are configured to simultaneously receive multiple triggered uplink transmissions, one triggered uplink transmission on each wireless link of the plurality of wireless links, from the STA MLD.

In some aspects, the processor is configured to cause at least one access point module of the plurality of access point modules to transmit on one wireless link of the plurality of wireless links or the plurality of access point modules on respective wireless links of the plurality of wireless links, a multi-link multi-STA block acknowledgment frame with an identifier for a STA of the STA MLD to acknowledge reception by the AP MLD of a triggered uplink transmission from the STA of the STA MLD.

In some aspects, the multi-link multi-STA block acknowledgment frame includes link identifier(s), association identifier(s) and traffic identifier(s) to indicate acknowledge of reception of triggered uplink transmissions from the STA MLD.

In some aspects, the multi-link multi-STA block acknowledgment frame includes a single block acknowledgment bitmap for all of the plurality of wireless links after pooling all received Media Access Control (MAC) Protocol Data Units (MPDUs) from all the plurality of wireless links.

In some aspects, the information indicating the allocation of groups of subcarriers for each of the plurality of wireless links is included in a Trigger Dependent User Info sub-field of a User Info field of the single trigger frame or in each of the multiple trigger frames.

In some aspects, the processor is further configured to include in a Target Wake Time (TWT) control frame information to indicate alignment of TWT schedule periods across the plurality of wireless links, and information to indicate single trigger multi-link synchronization across the plurality of wireless links with the single trigger frame or multi trigger multi-link synchronization across the plurality of wireless links with the multiple trigger frames.

The techniques described herein further relate to, or may be embodied in, one or more non-transitory computer readable storage media encoded with software including computer executable instructions and when the software is executed operable to perform operations by an access point multi-link device (AP MLD) to coordinate trigger-based uplink transmissions across multiple wireless links from a station MLD (STA MLD), the operations including: including, in a single trigger frame or in each of multiple trigger frames, information indicating an allocation of groups of frequency subcarriers to be used on each wireless link of the multiple wireless links for simultaneous uplink transmission from the STA MLD to the AP MLD; causing the AP MLD to transmit the single trigger frame on one wireless link of the multiple wireless links, or the multiple trigger frames simultaneously across the multiple wireless links to the STA MLD; and causing the AP MLD to receive multiple triggered uplink transmissions, one triggered uplink transmission on each wireless link of the multiple wireless links, from the STA MLD.

In some aspects, the techniques described herein relate to one or more non-transitory computer readable storage media, wherein the information indicating the allocation of groups of subcarriers includes information indicating Resource Unit (RU) position and RU size to be used on each wireless link of the multiple wireless links, wherein a Resource Unit denotes a group of frequency subcarriers.

In some aspects, the techniques described herein relate to one or more non-transitory computer readable storage media, wherein the operations further include causing the AP MLD to transmit on one wireless link of the multiple wireless links, or on respective wireless links of the multiple wireless links, a multi-link multi-STA block acknowledgment frame with an identifier for a STA of the STA MLD to acknowledge reception by the AP MLD of a triggered uplink transmission from the STA of the STA MLD.

In some aspects, the techniques described herein relate to one or more non-transitory computer readable storage media, wherein the multi-link multi-STA block acknowledgment frame includes link identifier(s), association identifier(s) and traffic identifier(s) to indicate acknowledgment of reception of triggered uplink transmissions from the STA MLD.

In some aspects, the techniques described herein relate to one or more non-transitory computer readable storage media, wherein the multi-link multi-STA block acknowledgment frame includes a single block acknowledgment bitmap for all of the multiple wireless links after pooling all received Media Access Control (MAC) Protocol Data Units (MPDUs) from all the multiple wireless links.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method by an access point multi-link device (AP MLD) to coordinate trigger-based uplink transmissions across multiple wireless links among wireless links setup between the AP MLD and a station MLD (STA MLD), comprising:
determining an allocation of groups of frequency subcarriers to be used on each wireless link of the multiple wireless links for simultaneous uplink transmission from the STA MLD to the AP MLD;
including, in a single trigger frame or in each of multiple trigger frames, information indicating the allocation of groups of frequency subcarriers to be used on each wireless link of the multiple wireless links; and
transmitting the single trigger frame on one wireless link of the multiple wireless links, or the multiple trigger frames simultaneously across the multiple wireless links to the STA MLD.

2. The method of claim 1, wherein the information indicating the allocation of groups of subcarriers comprises information indicating Resource Unit (RU) position and RU size to be used on each wireless link of the multiple wireless links, wherein a Resource Unit denotes a group of frequency subcarriers.

3. The method of claim 1, further comprising simultaneously receiving multiple triggered uplink transmissions, one triggered uplink transmission on each wireless link of the multiple wireless links, from the STA MLD.

4. The method of claim 3, further comprising transmitting on one wireless link of the multiple wireless links or on all the multiple wireless links, a multi-link multi-STA block acknowledgment frame with an identifier for a STA of the STA MLD to acknowledge reception by the AP MLD of a triggered uplink transmission from the STA of the STA MLD.

5. The method of claim 4, wherein the multi-link multi-STA block acknowledgment frame comprises a single block acknowledgment bitmap for all of the multiple wireless links after pooling all received Media Access Control (MAC) Protocol Data Units (MPDUs) from all the multiple wireless links.

6. The method of claim 4, wherein the multi-link multi-STA block acknowledgment frame includes link identifier(s), association identifier(s) and traffic identifier(s) to indicate acknowledge of reception of triggered uplink transmissions from the STA MLD.

7. The method of claim 1, wherein transmitting comprises transmitting to the STA MLD the single trigger frame on one wireless link of the multiple wireless links.

8. The method of claim 7, wherein the single trigger frame is used as a synchronization reference by the STA MLD for timing and carrier frequency offset for the multiple wireless links.

9. The method of claim 1, wherein transmitting comprises transmitting the multiple trigger frames to the STA MLD, each of the multiple trigger frames being transmitted on a corresponding one of the multiple wireless links.

10. The method of claim 9, wherein the multiple trigger frames transmitted across the multiple wireless links are synchronized so that in turn triggered uplink transmissions from the STA MLD are synchronized across the multiple wireless links.

11. The method of claim 1, wherein the information indicating the allocation of groups of subcarriers for each of the multiple wireless links is included in a Trigger Dependent User Info sub-field of a User Info field of the single trigger frame or in each of the multiple trigger frames.

12. The method of claim 1, further comprising:
including in a Target Wake Time (TWT) control frame information to indicate alignment of TWT schedule periods across the multiple wireless links, and information to indicate single trigger multi-link synchronization across the multiple wireless links with the single trigger frame or multi trigger multi-link synchronization across the multiple wireless links with the multiple trigger frames.

13. An apparatus comprising:
a plurality of access point modules each configured to wireless communicate over an associated wireless link of a plurality of wireless links for an access point multi-link device (AP MLD) with a station MLD (STA MLD); and
a processor coupled to the plurality of access point modules, the processor configured to perform operations including:
determining an allocation of groups of frequency subcarriers to be used on each wireless link of the plurality of wireless links for simultaneous uplink transmission from the STA MLD to the AP MLD;
including, in a single trigger frame or in each of multiple trigger frames, information indicating the allocation of groups of frequency subcarriers to be used on each wireless link of the plurality of wireless links; and
causing the single trigger frame to be transmitted by one of the plurality of access point modules on one wireless link of the plurality of wireless links, or causing the plurality of access point modules to each simultaneously transmit the multiple trigger frames across the plurality of wireless links to the STA MLD.

14. The apparatus of claim 13, wherein the information indicating the allocation of groups of subcarriers comprises information indicating Resource Unit (RU) position and RU size to be used on each wireless link of the plurality of wireless links, wherein a Resource Unit denotes a group of frequency subcarriers.

15. The apparatus of claim 13, wherein the plurality of access point modules are configured to simultaneously receive multiple triggered uplink transmissions, one triggered uplink transmission on each wireless link of the plurality of wireless links, from the STA MLD.

16. The apparatus of claim 15, wherein the processor is configured to cause at least one access point module of the plurality of access point modules to transmit on one wireless link of the plurality of wireless links or the plurality of access point modules on respective wireless links of the plurality of wireless links, a multi-link multi-STA block acknowledgment frame with an identifier for a STA of the STA MLD to acknowledge reception by the AP MLD of a triggered uplink transmission from the STA of the STA MLD.

17. The apparatus of claim 16, wherein the multi-link multi-STA block acknowledgment frame includes link identifier(s), association identifier(s) and traffic identifier(s) to indicate acknowledge of reception of triggered uplink transmissions from the STA MLD.

18. The apparatus of claim 16, wherein the multi-link multi-STA block acknowledgment frame comprises a single block acknowledgment bitmap for all of the plurality of wireless links after pooling all received Media Access Control (MAC) Protocol Data Units (MPDUs) from all the plurality of wireless links.

19. The apparatus of claim 13, wherein the information indicating the allocation of groups of subcarriers for each of the plurality of wireless links is included in a Trigger Dependent User Info sub-field of a User Info field of the single trigger frame or in each of the multiple trigger frames.

20. The apparatus of claim 13, wherein the processor is further configured to include in a Target Wake Time (TWT) control frame information to indicate alignment of TWT schedule periods across the plurality of wireless links, and information to indicate single trigger multi-link synchronization across the plurality of wireless links with the single trigger frame or multi trigger multi-link synchronization across the plurality of wireless links with the multiple trigger frames.

21. One or more non-transitory computer readable storage media encoded with software comprising computer executable instructions and when the software is executed operable to perform operations by an access point multi-link device (AP MLD) to coordinate trigger-based uplink transmissions across multiple wireless links from a station MLD (STA MLD), the operations comprising:
including, in a single trigger frame or in each of multiple trigger frames, information indicating an allocation of groups of frequency subcarriers to be used on each wireless link of the multiple wireless links for simultaneous uplink transmission from the STA MLD to the AP MLD;
causing the AP MLD to transmit the single trigger frame on one wireless link of the multiple wireless links, or the multiple trigger frames simultaneously across the multiple wireless links to the STA MLD; and
causing the AP MLD to receive multiple triggered uplink transmissions, one triggered uplink transmission on each wireless link of the multiple wireless links, from the STA MLD.

22. The one or more non-transitory computer readable storage media of claim 21, wherein the information indicating the allocation of groups of subcarriers comprises information indicating Resource Unit (RU) position and RU size to be used on each wireless link of the multiple wireless links, wherein a Resource Unit denotes a group of frequency subcarriers.

23. The one or more non-transitory computer readable storage media of claim 21, wherein the operations further comprise causing the AP MLD to transmit on one wireless link of the multiple wireless links, or on respective wireless links of the multiple wireless links, a multi-link multi-STA block acknowledgment frame with an identifier for a STA of the STA MLD to acknowledge reception by the AP MLD of a triggered uplink transmission from the STA of the STA MLD.

24. The one or more non-transitory computer readable storage media of claim 23, wherein the multi-link multi-STA block acknowledgment frame includes link identifier(s), association identifier(s) and traffic identifier(s) to indicate acknowledgment of reception of triggered uplink transmissions from the STA MLD.

25. The one or more non-transitory computer readable storage media of claim 23, wherein the multi-link multi-STA block acknowledgment frame comprises a single block acknowledgment bitmap for all of the multiple wireless links after pooling all received Media Access Control (MAC) Protocol Data Units (MPDUs) from all the multiple wireless links.
